(19) United States
(12) Patent Application Publication
(10) Pub. No.: US 2009/0244387 A1
(43) Pub. Date: Oct. 1, 2009

(54) Display device and driving method thereof with improved luminance

(76) Inventors: Jae-Sung Lee, Suwon-si (KR); Chang-Hoon Lee, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/320,010

(22) Filed: Jan. 14, 2009

(30) Foreign Application Priority Data
Mar. 31, 2008 (KR) 10-2008-0029750

(51) Int. Cl. H04N 9/69; G06T 15/00; G09G 5/00; H04N 15/00

(52) U.S. Cl. 348/674; 345/419; 345/690; 348/51; 348/E09.054

(57) ABSTRACT

A display device and a driving method thereof in which if an input 2D/3D video signal is a 2D video signal, an image data signal is generated by applying a first gamma correction curved line. If the input 2D/3D video signal is a 3D video signal, an image data signal is generated by applying the second gamma correction curved line. Luminance of a maximum grayscale of the first gamma correction curved line is set to be lower than luminance of a maximum grayscale of the second gamma correction curved line. Therefore, it is possible to prevent luminance of the display device from deteriorating by a barrier in a 3D driving mode.

### CLAIM OF PRIORITY

This application makes reference to, incorporates the same herein, and claims all benefits accruing under 35 U.S.C. §119 from an application earlier filed in the Korean Intellectual Property Office on 31 Mar. 2008 and there duly assigned Serial No. 10-2008-0029750.

### BACKGROUND OF THE INVENTION

1. Field of the Invention

The present invention relates a display device and a driving method thereof.

2. Description of the Related Art

In general, primary factors that cause a human to perceive a stereoscopic effect are a physiological factor and an experiential factor. In a 3-dimensional (3D) image displaying technology, binocular parallax is generally used to express the stereoscopic effect of an object. The binocular parallax is a primary factor of recognizing the stereoscopic effect at short distances.

In order to display a stereoscopic image, a display device spatially divides a left image and a right image using optical elements. Representatively, a lenticular lens array or a parallax barrier has been used. The display device using the parallax barrier advantageously has the capability to display a 2-dimensional (2D) image and a 3D image.

The display device using the parallax barrier includes a barrier disposed on a front surface of a display panel. When the display device displays a 2D image, the barrier forms a transparent region, thereby transmitting an image displayed on a display panel as it is. On the contrary, when the display device displays a 3D image, the barrier mixedly forms the transparent region and a non-transparent region, thereby transmitting images of pixels for a left-eye image to a left eye side and transmitting images of pixels for a right-eye image to a right eye side.

However, when the display device displays a 3D image in this way, the barrier decreases the luminance of the display device by about 50%, compared with luminance of the display device that displays a 2D image.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a display device and a driving method thereof having the advantage of improving luminance.

An exemplary embodiment of the present invention provides a display device including a plurality of first and second pixels, a barrier, and a controller. The barrier forms a transparent region and a non-transparent region for transmitting images of the plurality of first and second pixels in a first mode and for making an image of the plurality of first pixels and an image of the plurality of second pixels to be observed at different points. The controller determines one of the first mode and the second mode according to a video signal and generates image data by gamma-correcting the video signal according to the determined mode. The controller sets up a first luminance of image data generated by gamma-correcting the video signal of a maximum grayscale in the first mode to be different from a second luminance of image data generated by gamma-correcting the video signal in the second mode.

Another exemplary embodiment of the present invention provides a driving method for a display device including a display unit having a plurality of first and second pixels, and a barrier for selectively forming a transparent region and a non-transparent region for transmitting or not transmitting images displayed on the display unit. In the method, one of a first mode and a second mode is determined according to an input video signal. First image data is generated by forming the barrier as a transparent region and gamma-correcting the video signal when the first mode is determined. Then, second image data is generated by forming the barrier as a transparent region and an non-transparent region to make an image of the plurality of first pixels and an image of the plurality of second pixels to be observed from different points and gamma-correcting the video signal when the second mode is determined. Here, a first luminance of a maximum grayscale of the first image data is different from a second luminance of a maximum grayscale of the second image data.

According to an exemplary embodiment of the present invention, it is possible to prevent luminance from deteriorating in a 3D driving mode and to control white balance by determined a driving mode according to an input video signal and setting up a gamma correction curved line differently according to a 3D driving mode.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating a display device in accordance with an exemplary embodiment of the present invention.

FIG. 2 is an equivalent circuit of a pixel in a display device shown in FIG. 1.

FIG. 3 is a cross-sectional view of a barrier and a display unit taken along the line III-III′ in a display device in accordance with an exemplary embodiment of the present invention.

FIG. 4 is a drawing illustrating a stereoscopic image display operation of a display device in accordance with an exemplary embodiment of the present invention.

FIG. 5 is a drawing illustrating a stereoscopic image display operation of a display device according to another exemplary embodiment of the present invention.

FIG. 6 is a block diagram illustrating a controller in accordance with an exemplary embodiment of the present invention.

FIG. 7 is a graph illustrating a 2D gamma correction curved line in accordance with an exemplary embodiment of the present invention.

FIG. 8 is a graph illustrating a 3D gamma correction curved line in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follows, unless explicitly described to the contrary, the word “comprise” and variations such as “comprises” or “comprising” will be understood to imply the inclusion of stated elements but not the exclusion of any other elements.

Hereinafter, a display device and a driving method thereof according to an exemplary embodiment of the present invention will be described with reference to accompanying drawings.

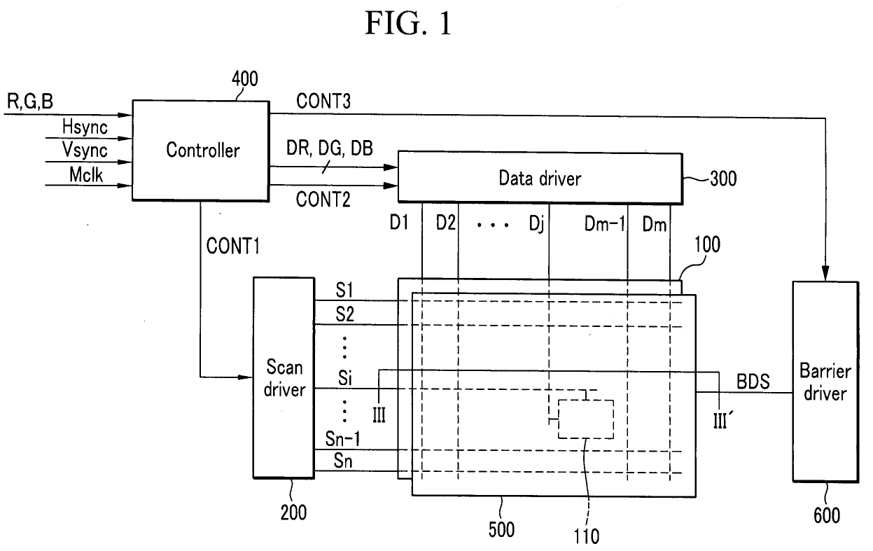

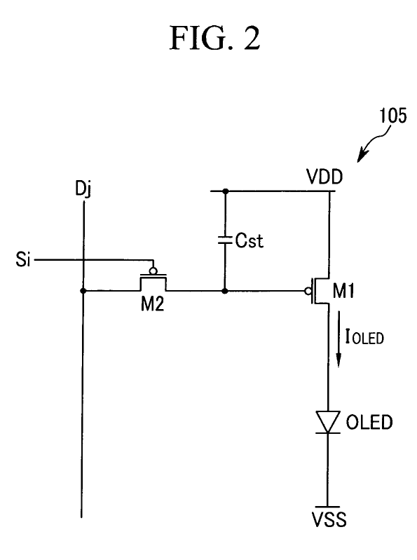

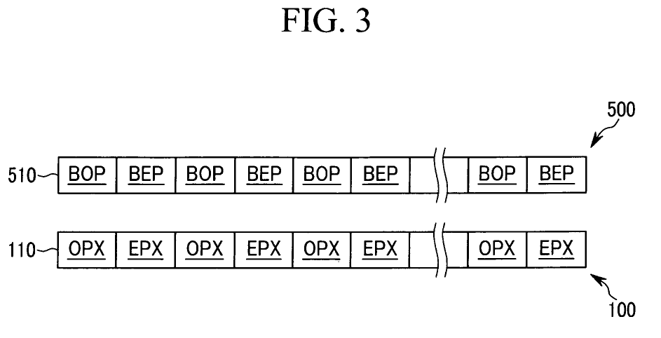

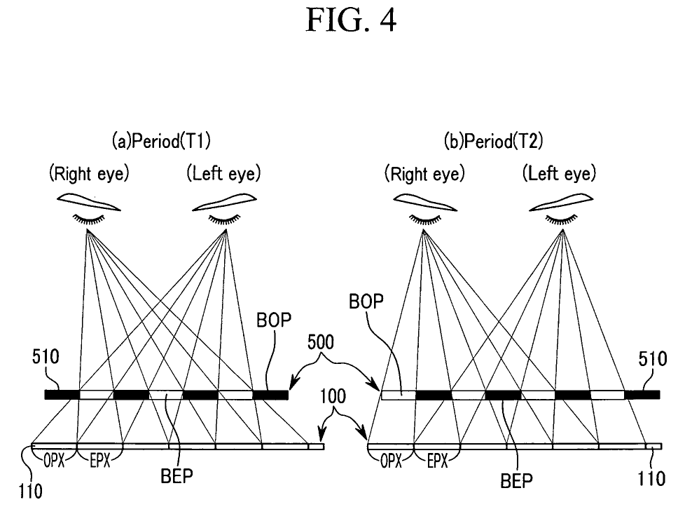

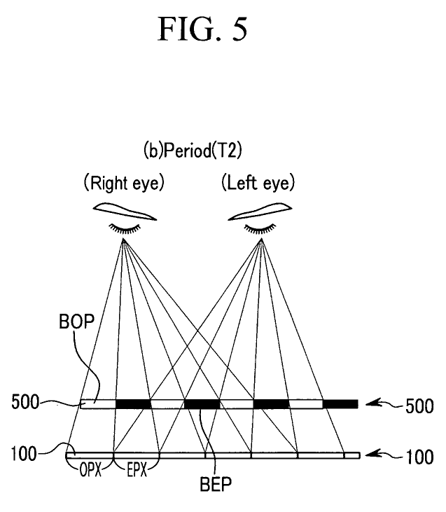

FIG. 1 is a block diagram illustrating a display device according to an exemplary embodiment of the present invention, FIG. 2 is an equivalent circuit of one pixel of a display device shown in FIG. 1, and FIG. 3 is a cross-sectional view of a barrier and a display unit taken along the line III-III′ in a display device according to an exemplary embodiment of the present invention. FIG. 4 is a drawing illustrating stereoscopic image display operation of a display device according to an exemplary embodiment of the present invention, and FIG. 5 is a drawing illustrating stereoscopic image display operation of a display device according to another exemplary embodiment of the present invention.

Referring to FIG. 1, the display device according to an exemplary embodiment of the present invention includes a display unit 100, a scan driver 200, a data driver 300, a controller 400, a barrier 500, and a barrier driver 600.

In an equivalent circuit, the display unit 100 includes a plurality of signal lines S1-Sn and D1-Dm, a plurality of voltage lines (not shown), and a plurality of pixels 110 connected to the signal lines and the voltage lines and arranged basically in a matrix format.

The plurality of signal lines S1-Sn and D1-Dm include a plurality of scan lines S1-Sn for transferring a scan signal and a plurality of data lines D1-Dm for transferring a data signal. The plurality of scan lines S1-Sn extend basically in a row direction to run almost parallel to each other, and the plurality of data lines D1-Dm extend basically in a column direction to run almost parallel to each other. Here, the data signal may be a voltage signal (referred to as data voltage) or a current signal (referred to as data current) according to the type of pixel 110. Hereinafter, the data signal will be described as a data voltage.

Referring to FIG. 2, each of the pixels 110 connected to an i^{th} scan line Si and a j^{th} data line Dj includes an organic light emitting element (OLED), a driving transistor M1, a capacitor Cst, and a switching transistor M2. Here, i=1, 2, . . . , n, and j=1, 2, . . . , m.

The switching transistor M2 includes a control terminal, an input terminal, and an output terminal. The control terminal is connected to the scan line Si, the input terminal is connected to the data line Dj, and the output terminal is connected to the driving transistor M1. The switching transistor M2 transfers a data signal applied to the data line Dj in response to a scan signal applied to the scan line Si. That is, the switching transistor M2 transfers a data voltage.

The driving transistor M1 also includes a control terminal, an input terminal, and an output terminal. The control terminal is connected to the switching transistor M2, the input terminal is connected to the driving voltage VDD, and the output terminal is connected to the organic light emitting element (OLED). The driving transistor M1 applies a current I_{OLED} having a size that is changed according to a voltage loaded between the control terminal and the output terminal.

The capacitor Cst is connected between the control terminal and the input terminal of the driving transistor M1. The capacitor Cst charges a data voltage applied to the control terminal of the driving transistor M1 and sustains the charged data voltage after the switching transistor M2 is turned off.

The organic light emitting element (OLED) may be an organic light emitting diode (OLED). The OLED includes an anode connected to the output terminal of the driving transistor M1 and a cathode connected to a common voltage VSS. The OLED emits light by changing intensity thereof depend on the output current I_{OLED} of the driving transistor M1, thereby displaying an image.

The OLED can emit light with one of primary colors. For example, the primary colors may be red, green, and blue. A desired color may be displayed through a spatial or temporal sum of the three primary colors. In this case, some of OLEDs can emit white light. As a result, luminance may be improved. Although an unlikely occurrence, OLEDs of all pixels 110 may emit white light, and some pixels 110 may further include a color filter (not shown) for changing white light to one of the primary colors.

The switching transistor M2 and the driving transistor M1 are a p-channel field effect transistors (FETs). In this case, the control terminal, the input terminal, and the output terminal are equivalent to a gate, a source, and a drain, respectively. However, at least one of the switching transistor M2 and the driving transistor M1 may be an n-channel field effect transistor. Also, connection of the transistors M1 and M2, the capacitor Cst, and the organic light emitting element (OLED) may be changed.

The pixel 110 shown in FIG. 2 is only an example of a pixel in a display device. Another type of pixel having at least two transistors or at least one capacitor may be used. As described above, a pixel receiving a data current as a data signal may be used.

Referring to FIG. 1 and FIG. 3, the barrier 500 includes a plurality of barrier pixel rows 510. Each of the barrier pixel rows 510 includes a plurality of barrier pixels BOP and BEP arranged in a row direction. A plurality of barrier pixels BOP and BEP of a barrier pixel row correspond to a plurality of pixels arranged in a row direction in a pixel row of the display device 100 in a one-to-one manner. Although unlikely, the barrier 500 may include fewer barrier pixel rows than pixel rows of the display device 100. In this case, one barrier pixel row corresponds to a plurality of pixel rows.

Such barrier pixels BOP and BEP may be formed as two substrates facing each other with a liquid crystal layer (not shown) injected between the two substrates. In this case, a polarizer may be formed on the two substrates or one of the two substrates. Here, the arrangement of liquid crystal molecules of the liquid crystal layer varies according to voltage size between electrodes (not shown) formed at the two substrates so that the polarization of the light that passes through the liquid crystal layer changes. The change in the polarization causes a change in transmittance of light by a polarizer.

Referring to FIG. 4, the display device according to an exemplary embodiment of the present invention displays a stereoscopic image by temporally dividing one frame into two fields T1 and T2. In the field Ti, even barrier pixels BEP operate as a transparent region for transmitting light and odd barrier pixels BOP operate as a non-transparent region for blocking light. In the other field T2, the even barrier pixels BEP operate as the non-transparent region and the odd barrier pixels BOP operate as the transparent region.

When the odd barrier pixels BOP operate as the non-transparent region and the even barrier pixels BEP operate as the transparent region, odd pixels OPX of a pixel row operate as pixels corresponding to a left eye of an observer. Hereinafter, the odd pixels OPX are referred as left-eye pixels. Even pixels EPX operate as pixels corresponding to a right eye of an observer. Hereinafter, the even pixels EPX are referred as right-eye pixels. On the contrary, when the odd barrier pixels BOP operate as the transparent region and the even barrier pixels BEP operates as the non-transparent region, odd pixels OPX operate as the right-eye pixels and even pixels BEP operate as the left-eye pixels. When the observer recognizes the right-eye image emitted from the right-eye pixels and the left-eye image emitted from the left-eye pixels through a left eye and a right eye, the observer perceives a stereoscopic effect like seeing a real stereoscopic object through the left eye and the right eye.

On the contrary, referring to FIG. 5, a display device according to another exemplary embodiment of the present invention always sets up odd barrier pixels (BOP) as a transparent region and even barrier pixels BEP as a non-transparent region when a stereoscopic image is displayed. Then, the odd pixels OPX always operate as the right-eye pixels, and the even pixels EPX always operate as the left-eye pixels. Therefore, an observer recognizes an image of the even pixels EPZX through a left eye, and recognizes an image of the odd pixels OPX through a right eye, thereby perceiving a stereoscopic effect. Although an unlikely occurrence, the odd barrier pixels BOP may always operate as a non-transparent region and the even barrier pixels BEP may always operate as a transparent region.

In FIG. 3 to FIG. 5, if the barrier 500 includes a plurality of barrier pixel rows 510, one barrier pixel row 510 and another barrier pixel row 510 may identically form transparent and non-transparent regions, or may alternatively form transparent and non-transparent regions.

In FIG. 3 to FIG. 5, one barrier pixel BOP/BEP is shown to correspond with one pixel 110. Although unlikely, one barrier pixel BOP/BEP may correspond to a unit pixel for displaying color, for example, three pixels for red, green, and blue colors.

When the display device displays a plane image, all of barrier pixels BOP/BEP of the barrier 500 in FIG. 3 to FIG. 5 are set up as a transparent region.

Referring to FIG. 1 again, the scan driver 200 is connected to the scan lines S1-Sn of the display unit 100. The scan driver 200 sequentially applies a scan signal to the scan lines S1-Sn. The scan signal is a combination of a gate-on voltage Von for turning on a switching transistor M2 and a gate-off voltage (Voff) for turning off a switching transistor M2. If the switching transistor M2 is a p-channel field effect transistor, the gate-on voltage (Von) and the gate-off voltage (Voff) are a low voltage and a high voltage, respectively.

The data driver 300 is connected to the data lines D1-Dm of the display unit 100. The data driver 300 receives image data DR, DG, and DB from the controller 400, transforms the received image data DR, DG, and DB to data voltages, and applies the data voltages to the data lines D1-Dm.

The controller 400 controls the scan driver 200, the data driver 300, and the barrier driver 600. The controller 400 receives input video signals R, G, and B from an external device and receives an input control signal for controlling display of the received input video signals. The input video signal includes luminance information of each pixel 110 and the luminance has a predetermined number for grayscale, for example 1024 (=2¹⁰), 256 (=2⁸) or 64 (=2⁶) grayscales. For example, input control signals are a horizontal synchronization signal Hsync, a vertical synchronization signal Vsync, and a main clock signal Mclk. The input video signal R, G, and B may be one of a plane image signal and a stereoscopic image signal. The stereoscopic image signal includes stereoscopic graphic data having 3D space coordinate and surface information of an object, which is stereoscopically displayed on a plane, and image data of each view point. When a plane image and a stereoscopic image are displayed on the display unit 100 together, the input video signal includes both of the plane image signal and the stereoscopic image signal.

The controller 400 generates a scan control signal CONT1, a data control signal CONT2, and a barrier control signal CONT3 by processing the input video signal R, G, and B properly for operation conditions of the display unit 100 and the barrier 500 based on the input video signal R, G, and B and the input control signal. Meanwhile, the controller 400 generates image data DR, DG, and DB from the input video signal through gamma correction. The controller 400 uses different gamma correction curved lines for a 2D driving mode for displaying a plane image and a 3D driving mode for displaying a stereoscopic image. The controller 400 transfers the scan control signal CONT1 to the scan driver 200, transfers the data control signal CONT2 and the processed image data DR, DG, and DB to the data driver 300, and transfers the barrier control signal CONT3 to the barrier driver 600.

The barrier driver 600 generates a barrier driving signal BDS for driving the barrier 500 according to the barrier control signal CONT3 and transfers the generated barrier driving signal BDS to the barrier 500.

Hereinafter, operations of the display device will be described in detail.

According to the data control signal CONT2 from the controller 400, the data driver 300 receives the image data DR, DG, and DB for pixels of one row, transforms the input image data DR, DG, and DB to data voltages, and applies the data voltages to corresponding data lines D1-Dm.

The scan driver 200 turns on the switching transistor M2 connected to the scan lines S1-Sn by applying the gate-on voltage Von to the scan lines S1-Sn according to the scan control signal CONT1 from the controller 400. Then, the data voltage applied to the data lines D1-Dm is transferred to a corresponding pixel 110 through the turned-on switching transistor M2.

The driving transistor M1 receives the data voltage through the turned-on switching transistor M2, and the OLED emits light with intensity corresponding to the output current I_{OLED}.

By repeating the same operations in units of 1 horizontal period (one period of the horizontal synchronization signal Hsync), the gate-on voltage Von is sequentially applied to all scan lines S1-Sn and the data voltage is applied to all pixels 110, thereby displaying an image of one frame or one field.

In the driving method of FIG. 4, the barrier driver 600 sets up odd barrier pixels BOP and even barrier pixels BEP as a non-transparent region and a transparent region, respectively, in one field according to a carrier control signal CONT3 in the 3D driving mode. Then, the barrier driver 600 sets up the odd barrier pixels BOP and the even barrier pixels BEP as the transparent region and the non-transparent region in a next field, thereby displaying a stereoscopic image of one frame.

On the contrary, according to the driving method of FIG. 5, the barrier driver 600 sets up odd barrier pixels BOP and even barrier pixels BEP of the barrier 500 as the transparent region and the non-transparent region according to the barrier control signal CONT3 in the 3D driving mode, thereby displaying a stereoscopic image of one frame.

Meanwhile, in the 2D driving mode, the barrier driver 600 sets up the odd barrier pixels BOP and the even barrier pixels BEP of the barrier 500 as the transparent region according to the barrier control signal CONT3, thereby displaying a plane image in one frame.

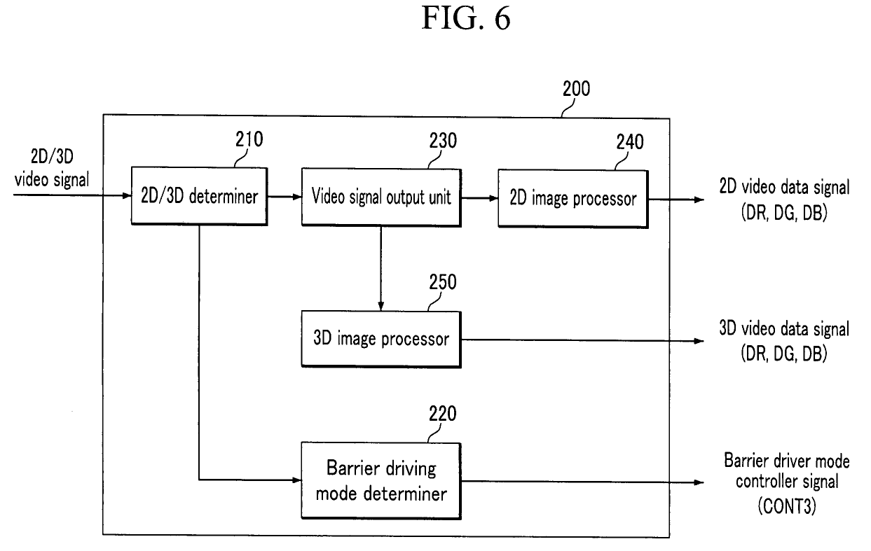

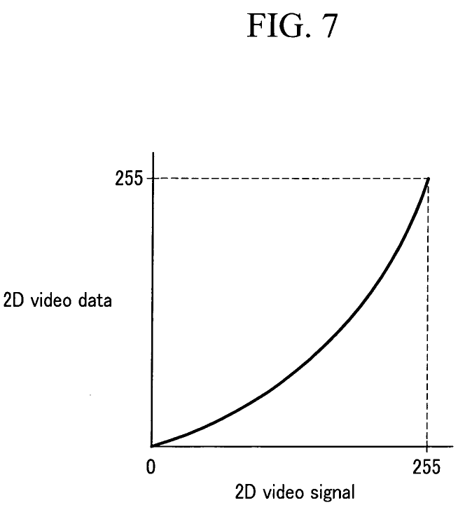

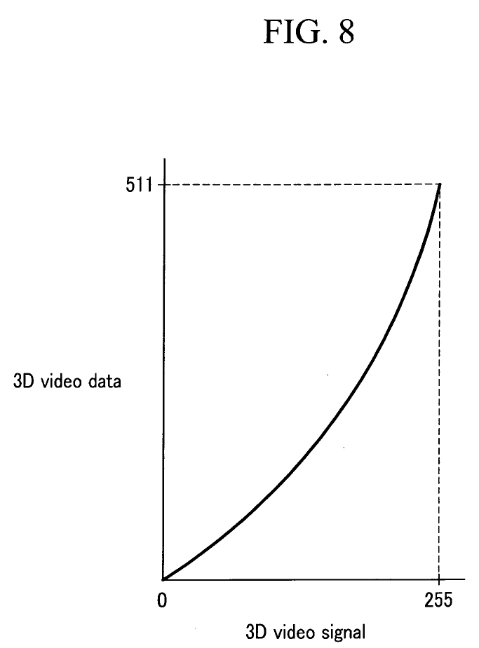

FIG. 6 is a block diagram illustrating a controller in accordance with an exemplary embodiment of the present invention, FIG. 7 is a graph illustrating a 2D gamma correction curved line in accordance with an exemplary embodiment of the present invention, and FIG. 8 is a graph illustrating a 3D gamma correction curved line in accordance with an exemplary embodiment of the present invention.

As shown in FIG. 6, the controller 200 includes a 2D/3D determiner 210, a barrier driving mode determiner 220, a video signal output unit 230, a 2D image processer 240, and a 3D image processer 250.

The 2D/3D determiner 210 determines whether a video signal is a 2D video signal or a 3D video signal by analyzing the video signal, and determines a driving mode based on the determination result. For example, the video signal may include an additional determination signal for a 2D video signal and a 3D video signal. The 2D/3D determiner 210 may determine whether an input video signal is a 2D video signal or a 3D video signal by recognizing the additional determination signal. If the video signal is the 2D video signal, the 2D/3D determiner 210 determines a driving mode of a display device as a 2D driving mode. If the video signal is the 3D video signal, the 2D/3D determiner 210 determines a driving mode of a display device as a 3D driving mode.

The barrier driving mode determiner 220 generates a barrier control signal CONT3 according to the driving mode determined by the 2D/3D determiner 210 and outputs the generated barrier control signal CONT3 to the barrier driver 500.

In the case of a 2D driving mode, the barrier driving mode determiner 220 generates a barrier control signal CONT3 in order to set up all of odd barrier pixels BOP and even barrier pixels BEP of the barrier 500 as a transparent region. Then, the barrier 500 transmits images of all pixels displayed on the display unit 100.

In the case of the 3D driving mode, according to the driving method of FIG. 4, the barrier driving mode determiner 220 generates a barrier control signal CONT3 in order to set up odd barrier pixels BOP and even barrier pixels BEP of the barrier 500 as the non-transparent region and the transparent region, respectively, in one field, and set up odd barrier pixels BOP and even barrier pixels BEP of the barrier 500 as the transparent region and the non-transparent region, respectively, in the next field.

In the case of a 3D driving mode, according to the driving method of FIG. 5, the barrier driving mode determiner 220 generates a barrier control signal CONT3 for setting up odd barrier pixels BOP and even barrier pixels BEP of the barrier 500 as the transparent region and the non-transparent region for one frame.

Then, the barrier 500 sets up barrier pixels as the transparent region or the non-transparent region according to the barrier control signal CONT3.

The video signal output unit 230 outputs the video signal to the 2D image processor 240 or the 3D image processor 250 according to the driving mode from the 2D/3D determiner 210.

The 2D image processer 240 generates 2D image data based on the input 2D video signal and outputs the generated image data signals DR, DG, and DB to the data driver 400. In more detail, the 2D image processer 240 generates 2D image data DR, DG, and DB by applying the 2D video signal to a 2D gamma correction curved line.

The 3D image processer 250 generates a 3D image data signal based on the input 3D video signal, and outputs the generated image data signals DR, DG, and DB to the data driver 400. In more detail, the 3D image processer 250 generates 3D image data DR, DG, and DB by applying the 3D video signal to a 3D gamma correction curved line.

Such a gamma correction curved line may be stored in a memory in a form of a lookup table.

Hereinafter, a method for generating an image data signal using a gamma correction curved line shown in FIG. 7 and FIG. 8 will be described. FIG. 7 is a graph illustrating a 2D gamma correction curved line, and FIG. 8 is a graph illustrating a 3D gamma correction curved line. Referring to FIG. 7 and FIG. 8, the maximum luminance of image data transformed and outputted by the 3D gamma correction curved line is set to be about two times the maximum luminance of image data transformed and outputted by the 2D gamma correction curved line in the present embodiment.

For example, if the 2D gamma correction curved line transforms an input video signal of from 0 to 255 grayscale to image data of from 0 to 255 grayscale, the 3D gamma correction curved line transforms an input video signal from 0 to 255 grayscale to image data of from 0 to 511 grayscale. As described above, luminance is prevented from deteriorating by enabling the controller 400 to set the maximum grayscale luminance of the image data DR, DG, and DB in the 3D driving mode to be higher than the maximum grayscale luminance in the 2D driving mode. For example, the maximum grayscale luminance for the 3D driving mode is set about twice as much as that for the 2D driving mode.

Meanwhile, in a pixel shown in FIG. 2, the output current I_{OLED} of the driving transistor M1 becomes like Equation 1. Therefore, the data driver 300 can control output luminance by changing data voltage Vdata according to image data DR, DG, and DB transferred from the controller 400.

$${I}_{OLED} = \frac{β}{2} ( {V}_{gs} - {\vert Vth \vert}^{2} = \frac{β}{2} {( Vdata - VDD - \vert Vth \vert )}^{2} \qquad Equation 1$$

In Equation 1, the Vgs voltage is a voltage applied between the input terminal and the control terminal of the driving transistor M1, and the Vth voltage is a threshold voltage of the driving transistor M1.

For example, it is assumed that absolute values |Vth| of the driving voltage VDD and the threshold voltage of the driving transistor M1 are 5V and 0.7V, and that the data voltage Vdata corresponding to the 0 grayscale and to the 255 grayscale are 4.3V and 2V. Under these assumptions, the data driver 300 can express grayscales from 0 to 255 by properly selecting voltages from 4.3V to 2V. Here, if the data voltage Vdata is 1V, the output current I_{OLED} becomes about twice the output current I_{OLED} generated when data voltage Vdata is 2V. Therefore, the data driver 300 can express 511 grayscales by setting data voltages Vdata corresponding to a grayscale of 511 to 1V. The data driver 300 can express grayscales from 256 to 511 by properly selecting voltages between 2V and 1V.

As described above, when a data voltage range from 4.3V to 2V is used for a 2D driving mode, the data driver 300 can prevent luminance from deteriorating caused by the barrier 150 in the 3D driving mode using a wider data voltage range than that for the 2D driving mode, and for example, the data voltage range from 4.3V to 1V can be used for the 3D driving mode.

Since color coordinate characteristics are different for red R, green G, and blue B colors, the controller 200 may set up a gamma correction curved line differently for red, green, and blue in order to adjust white balance. That is, 3D gamma correction curved lines can be set differently for red, green, and blue image signals.

As described above, it is possible to control white balance and to prevent luminance from deteriorating in the 3D driving mode by setting up luminance of the maximum grayscale of the gamma correction curved lines differently for the 2D driving mode and the 3D driving mode.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a plurality of first and second pixels;
a barrier for forming a transparent region and a non-transparent region for transmitting images of the plurality of first and second pixels in a first mode and for causing an image of the plurality of first pixels and an image of the plurality of second pixels to be observed at different points; and
a controller for determining one of the first mode and the second mode according to a video signal and generating image data by gamma-correcting the video signal according to the determined mode,
wherein the controller sets up a first luminance of image data generated by gamma-correcting the video signal of a maximum grayscale in the first mode to be different from a second luminance of image data generated by gamma-correcting the video signal in the second mode.

2. The display device of claim 1, wherein the second luminance is higher than the first luminance.

3. The display device of claim 2, wherein the second luminance is twice that of the first luminance.

4. The display deice of claim 1, wherein the controller gamma-corrects the video signal using a first gamma correction curved line in the first mode and gamma-corrects the video signal using a second gamma correction curved line in the second mode where the second gamma correction curved line is different from the first gamma correction curved line.

5. The display device of claim 4, wherein a maximum grayscale of image data transformed by the second gamma correction curved line is higher than a maximum grayscale of image data transformed by the first gamma correction curved line.

6. The display device of claim 4, wherein the controller stores the first and second gamma correction curved lines in a form of a lookup table.

7. The display device of claim 4, further comprising a data driver for transferring a signal corresponding to the image data from the controller to the plurality of first and second pixels,
wherein the data driver sets a range of the data signal in the second mode to be wider than a range of the data signal in the first mode.

8. The display device of claim 4, wherein the video signal includes at least one of a first video signal corresponding to a first color and a second video signal corresponding to a second color, and
the controller sets the second gamma correction curved line applied to the first video signal differently from the second gamma correction curved line applied to the second video signal.

9. The display device of claim 1, wherein the first mode is a 2-dimensional (2D) driving mode and the second mode is a 3-dimensional (3D) driving mode.

10. A method for driving a display device including a display unit having a plurality of first and second pixels and a barrier for selectively forming a transparent region and a non-transparent region for transmitting or not transmitting images displayed on the display unit, comprising:
determining one of a first mode and a second mode according to an input video signal;
generating first image data by forming the barrier as a transparent region and gamma-correcting the video signal when the first mode is determined; and
generating second image data by forming the barrier as a transparent region and a non-transparent region to cause an image of the plurality of first pixels and an image of the plurality of second pixels to be observed from different points and gamma-correcting the video signal when the second mode is determined,
wherein a first luminance of a maximum grayscale of the first image data is different from a second luminance of a maximum grayscale of the second image data.

11. The method of claim 10, wherein the second luminance is higher than the first luminance.

12. The method of claim 11, wherein the second luminance is twice that of the first luminance.

13. The method of claim 10, wherein
the video signal includes at least one of a first video signal corresponding to a first color and a second video signal corresponding to a second color, and
in the generating of the second image data, the first video signal and the second video signal are gamma corrected to be different from each other.

14. The method of claim 10, wherein the first mode is a 2-dimensional (2D) mode and the second mode is a 3-dimensional (3D) mode.

15. The method of claim 10, further comprising:
transforming the first image data to a first data signal and transferring the first data signal to the display unit; and
transforming the second image data to a second data signal and transferring the second data signal to the display unit,
wherein a range of the second data signal is set to be wider than a range of the first data signal.

16. A method for driving a display device, comprising the steps of:
generating a first image data signal by applying a first gamma correction curved line when a 2-dimensional video signal is input;
generating a second image data signal by applying a second gamma correction curved line when a 3-dimensional video signal is input; and
maintaining a luminance level of said second image data signal to equal of that of said first image data signal,
wherein a luminance level of a maximum grayscale of the first gamma correction curved line is set lower than a luminance level of a maximum grayscale of the second gamma correction curved line.
